(19) United States
(12) Patent Application Publication
(10) Pub. No.: US 2006/0206919 A1
(43) Pub. Date: Sep. 14, 2006

(54) System and method of secure login on insecure systems

(75) Inventors: Michael Andrew Montgomery, Austin, TX (US); Asad Mahboob Ali, Austin, TX (US)

Correspondence Address: ANDERSON & JANSSON L.L.P., 9501 N. CAPITAL OF TX HWY #202, AUSTIN, TX, 78759, US

(73) Assignee: Axalto SA, Montrouge (FR)

(21) Appl. No.: 11/076,682

(22) Filed: Mar. 10, 2005

(51) Int. Cl. H04L 9/32

(52) U.S. Cl. 726/2

(57) ABSTRACT

A method for authenticating a user for use of a server computing device wherein the server computing device is connected by a network to a host device. Generating a key representation image having thereon a plurality of individual key images placed at random positions, each corresponding to a possible character value in an authentication phrase. Accepting a sequence corresponding to locations of mouse clicks representing user selections of character values in an attempted authentication phrase. Verifying that the sequence of location values corresponds to a correct authentication phrase by mapping the locations of the mouse clicks to the locations of the randomly placed key images. Alternatively, accepting a sequence corresponding to a transformation of personal identification number based on a random number and a numerical operation or selection in a matrix.

### TECHNICAL FIELD

The present invention relates generally to ensuring secure access to a computerized device and more particularly to a system and method for secure authentication of a user of a computerized device.

### BACKGROUND OF THE INVENTION

User authentication is one of the most vexing problems in the use of computerized devices. While computers have automated or even enabled many tasks, the use of computers and in particular the access of computerized services over networks has significantly increased risks. While security of personal and corporate data have been secured by the adoption of many security protocols and devices, e.g., encryption, secure protocols, and use of smart cards, these security mechanisms have seen attack in many different forms.

The use of user identification in conjunction with passwords or personal identification numbers (PIN) is one mechanism for protecting access to personal or private corporate data or services that require some form of authentication. Traditionally, the PIN is entered by a user in some type of text box and the PIN is transmitted to an authentication server.

However, passwords and PINs can be attacked and compromised even if these are transmitted over a secure channel in an encrypted form. For example, if an untrusted computer is used to enter an authorization phrase, software executing on that computer may be used to capture that PIN before the PIN has been passed to the encryption layer. Such software can be in the form of software that impersonates the service to which a user may seek access or in the form of keyboard loggers that capture keystrokes entered by users.

PINs and passwords can also be obtained by persons who simply look over the shoulder of a user entering such authorization phrases.

From the foregoing it will be apparent that there is still a need for an improved method to provide user authentication so as to enable secure authentication that is not prone to snooping, shoulder surfing, keyboard logging, or other schemes designed to usurp authentication phrases such as personal identification numbers (PIN) or passwords.

### SUMMARY OF THE INVENTION

In a preferred embodiment the invention provides a system and method allowing a user to securely log in to a server using an insecure system without imposing the risks of having the user's PIN, password or authorization phrase exposed to sniffing attacks, keyboard logging, shoulder surfing, or similar methods of attack. Such a system and method for secure login requires little overhead in terms of computational resources and storage, can readily be added to existing systems, requires no modification to host computers, and provides users with a hitherto unachieved level of security in logging in using insecure computers.

In response to a request to access a server computing device the server computing device is operated to generate a key representation image having thereon a plurality of individual key images placed at random positions, each corresponding to a possible character value in an authentication phrase. These key representations are transmitted by the server device to the host device using a network protocol. At the host device, the key representations are displayed using a standard web browser on which a user may click on these representations using standard mouse clicks. These mouse clicks are captured and transmitted as a sequence of location values from the host computer to the server computer. After receiving the sequence of location values from the host device transmitted using a network protocol, where the sequence of location values correspond to locations of mouse clicks representing user selections of character values in an attempted authentication phrase; the server device is operated to verify that the sequence of location values corresponds to a correct authentication phrase by mapping the locations of the mouse clicks to the locations of the randomly placed key images.

In another aspect of the invention, a user is authenticated for use of a server computing device wherein the server computing device is connected to a host device by a method including generating a random matrix and receiving from the host device a sequence of values corresponding an attempted authentication phrase wherein the sequence of values correspond to mouse clicks on digits in the random matrix. The attempted authentication phrase is then verified against an authorized authentication phrase wherein the authorized authentication phrase is a function of an authorized user's personal identification number (PIN), a transformation personal identification number (tPIN), and the random matrix.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a smart card according to the invention may be used to provide secure computing services.

FIG. 2 is a schematic illustration of an exemplary architecture of a computer system on which the server side of the invention may operate, for example, a smart card.

FIG. 3 is a block diagram of an exemplary software architecture that one may find implemented on a server side system according to the invention.

FIG. 4 is a screen shot of a user interface window presenting a user with an example of a virtual keypad according to the invention.

FIG. 5 is a flow-chart illustrating a method according to the invention of generating and displaying a virtual keypad to a user.

FIG. 6 is a flow chart illustrating a user's interaction with an augmented HTML page for the purpose of entering a PIN by using a web browser executing on a host computer to which an authentication server according to the invention may be connected.

FIG. 7 is a flow-chart illustrating the actions taken by the web server executing on server computer when processing the PIN sent from the browser.

FIG. 8 is a schematic illustration of the relationship between a random number key transmitted from an authentication server to a host computer for display to the user, a transformation PIN (tPIN), a user's PIN, a transformation logic, a transformation operation and a resulting virtual PIN (vPIN).

FIG. 9 is a flow-chart illustrating an approach used by the authentication server to use a random key approach of the present invention to generate and verify a one-time password vPIN.

FIG. 10 is a flow-chart illustrating the steps taken by the authentication server according to the invention to compute the expected vPIN and by the user to compute the vPIN for entry according to one aspect of the invention.

FIG. 11 is a flow-chart illustrating the use of a random-index transformation method for computing a vPIN from a PIN, a tPIN, and a random number provided by the authorization server according to one aspect of the invention.

FIG. 12 is a graphical illustration of one example of use of the random-index transformation of FIG. 11.

FIG. 13 is a graphical illustration of another variation to the random-index transformation according to the invention and as illustrated in FIG. 11 in which the PIN and tPIN are identical.

FIG. 14 is a schematic illustration of an embodiment of the invention in which a user only uses a PIN in conjunction with a random key to derive a vPIN according to another aspect of the invention.

FIG. 15 is a schematic illustration of an example in which a user only uses a PIN and a random number to generate the vPIN according to the aspect of the invention illustrated in FIG. 14.

FIG. 16 is a graphical illustration of a transformation matrix used in an alternative embodiment of the invention.

FIG. 17 is a schematic illustration of a network scenario in which two different users possess the PIN and tPIN, respectively to obtain access to a service protected by the authentication server.

FIG. 18 is a sequence diagram illustrating one possible dataflow and operations performed by two host computers operated by different users, and the authentication server to perform authentication of the two users to allow access to a resource.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Introduction

As shown in the drawings for purposes of illustration, the invention is embodied in a novel system and method for providing secure login on insecure systems. A system and method according to the invention provides a method in which a user may securely enter an authorization phrase, such as a PIN or a password, without the fear that the authorization phrase is being compromised in some manner. Existing methods for entry of authorization phrases are prone to various forms of attack or carry with them inherent limitations such as requiring users to possess tokens for generating one-time passwords (OTP) that require synchronization with a server.

In one aspect, a system and method according to the invention provide a mechanism by which a user may enter an authorization phrase on a randomized key pad in the form of an image displayed to user on a host computer. The host computer has no knowledge of the structure of the image. The user enters the authorization phrase by entering mouse clicks on the randomized key pad image and these mouse clicks are translated into a sequence communicated to a server device which may determine whether the clicks correspond to a correct authorization phrase. The image is difficult to programmatically parse to determine the structure. It is randomized for each use of the authorization phase. It may be further transformed by image manipulations. The host computing device does not need to be trusted. Furthermore, snooping the entered mouse clicks or the sequence that corresponds to the entered mouse clicks would not compromise the underlying authorization phrase. Thus, the present invention provides a higher level of security than previous mechanisms for entering authorization phrases.

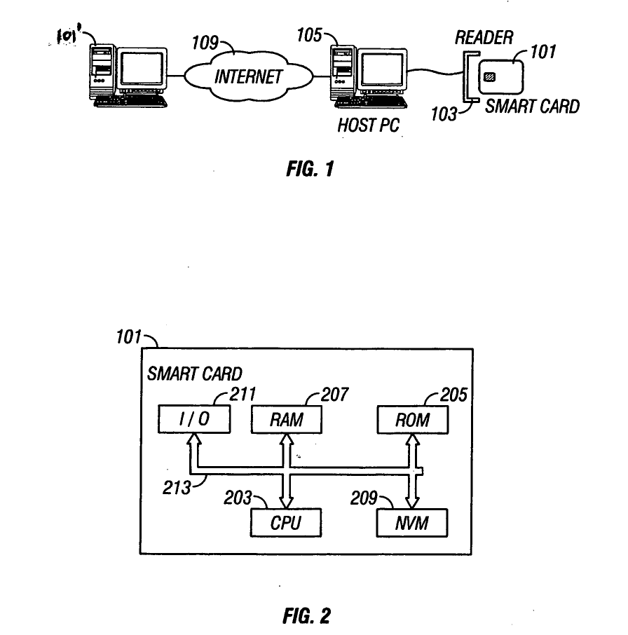

FIG. 1 is a schematic illustration of one possible operating environment 100 in which the present invention may be employed. In the operating environment 100 a smart card device 101 may be used to provide secure communication with a remote entity. The smart card 101 is connected to a computer network 109, for example, the Internet. The smart card 101 may be connected to the computer network 109 via a personal computer 105 that has attached thereto a card reader 103 for accepting a smart card. However, the smart card 101 may be connected in a myriad of other ways to the computer network 109, for example, via wireless communication networks, smart card hubs, or directly to the computer network 109. The remote node 101′ is a computer system of some sort capable to implement some functionality that may either seek access to information on the smart card 101 or to which a user may seek access. For example, the remote node 101′ may be executing banking software that a user of the smart card 101 is seeking to obtain access to. The smart card 101 may then provide some access control functionality or may even be an electronic purse to which funds are downloaded from the remote computer.

The scenario of FIG. 1 is presented here merely for the purpose of providing an example and must not be taken to limit the scope of the invention whatsoever. Only the imagination of designers limits the myriad of possible deployment scenarios and uses for the invention.

The scenario of FIG. 1 is useful to illustrate the invention. However, the invention should not be limited to smart cards and the use of smart cards. FIG. 1 provides a useful illustration in that a smart card 101 is a secure device to which a user must gain access for obtaining information stored thereon. Smart cards do not in of themselves provide a user interface by which a user to interact directly with the smart card or the information that is stored on the smart card. In the illustration of FIG. 1, a user interacts with the smart card over a user interface provided on the host computer 105. Throughout this document the terms server and client are used to describe the entities to which a user seeks access and on which the user is entering authorization phrases to obtain that access. In the example of FIG. 1, the smart card 101 is a server of information and the host computer 105 is a client of that same information. However, it is only an example. In other embodiments of the invention, the server is a computer located somewhere on a computer network and the client is another computer that a user happens to be using. The server could be an e-commerce site, and the client, a computer in an Internet cafe. The server could be a bank account database, and the client, an ATM machine. And so on.

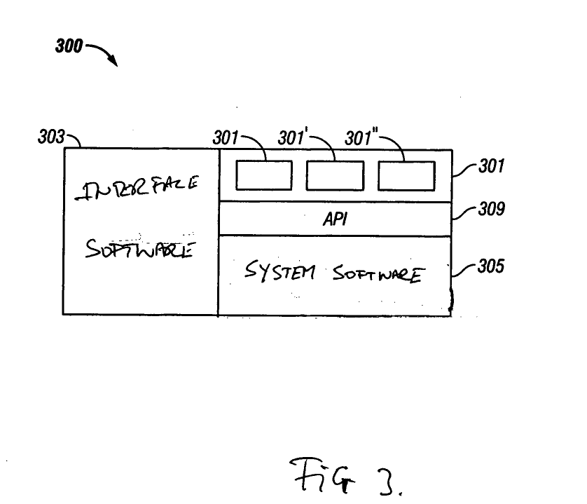

FIG. 2 is a schematic illustration of an exemplary architecture of a computer system on which the server side of the invention may operate, for example, smart card 101. The server side device 101, e.g., a smart card, has a central processing unit 203, a read-only memory (ROM) 205, a random access memory (RAM) 207, a non-volatile memory (NVM) 209, and a communications interface 211 for receiving input and placing output to a device, e.g., the card reader 102, to which the smart card device 101 is connected. These various components are connected to one another, for example, by bus 213. During operation, the CPU 203 operates according to instructions in the various software modules stored in the ROM 205.

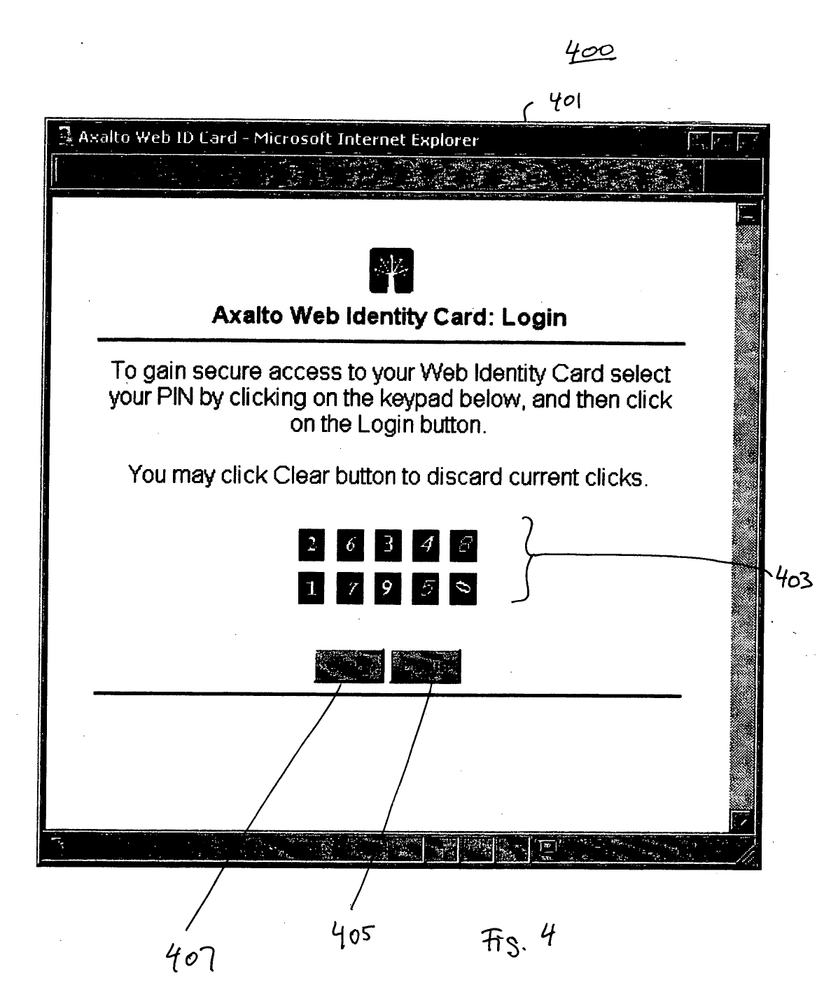

FIG. 3 is a block diagram of an exemplary software architecture 300 that one may find implemented on a server side system 101. The software architecture 300 includes several application programs 301, e.g., application programs 301, 301′, and 301″. These interface with other computer systems or other computer hardware through some communications interface software 303. In the case of smart cards, the application programs 301 would typically be loaded into the non-volatile memory 209. However, in other scenarios an application program may be permanently written onto the smart card at manufacture by having it stored on a secondary storage such as a hard disk. During execution of an application program, certain portions of the application program are loaded into the RAM 207.

In this example, several application programs 301 are executed by the CPU 203 under the control of instructions of a system software 305. The system software 303 may, for example, be a Javacard Virtual Machine as found on the Cyberflex smart card family from Axalto Inc. or the interpreter of a smart card implementing a .NET CLI (Common Language Infrastructure) as found in the NET smart card technology from Axalto Inc. (www.axalto.com/infosec/NET_faq.asp). In alternative embodiments, the application programs 301 are compiled into executable code and do not require further interpretation by the interpreter 305. However, in such embodiments, the job control would be managed by some operating system program that would take the place of the interpreter 303. The application programs 301 may access functions provided by the smart card system software 307 by issuing calls through an application program interface 309.

Secure Login Methodology

As described herein above, a problem that arises when a user uses one computer, e.g., host PC 105, to enter an authorization phrase to gain access to another computer, e.g., the smart card 101 or a remote computer 101′, is that the authorization phrase may be compromised in some manner. The present invention provides a methodology whereby users can be authenticated to a local or remote system by entering an authorization phrase, e.g., a PIN or a password. Any mal-ware that may be installed on the host PC 105 cannot capture the PIN or password as the user enters it. The methodology is based on two sets of approaches. One approach uses random digital scrambling of images, which are then selected by user when entering the PIN. The second approach uses a simple mathematical transformation that is based on a predefined formula. This transformation can generate a virtual PIN that can be used as an OTP without requiring a separate hardware token. Both sets of approaches can be particularly useful when logging in through insecure systems that have mal-ware installed. The following sections describe each of these approaches.

The server side of the methodology of the invention may be implemented as an application program 301 as illustrated in FIG. 3.

Virtual Keypad

In one aspect of the invention a user is presented with a virtual keypad. FIG. 4 is a screen shot 400 of a user interface window 401 presenting a user with an example of a virtual keypad 403. As illustrated, the virtual keypad 403 contains 10 key images. The key images are presented to the user in a random order, e.g., as seen in FIG. 4. While the 10 digits used in the decimal number system are used in this example and throughout this document, it should be noted that it is merely an example. In other embodiments a full alphanumeric keyboard may be presented to allow users to enter passwords having letters or symbols. In other embodiments, other sets of symbols may be used, e.g., a certain number of letters, the digits of the hexadecimal number system. Only a designer's imagination and practical considerations limit the number of keys and which keys and symbols to use. However, for purposes of example, a 10-digit alphabet is used herein.

The virtual keypad drastically reduces the likelihood that a PIN or password can be captured by malicious software as it is typed into a computer. The conventional mode of entering a password requires the use of a keyboard. Keystroke loggers can capture each keystroke, and thereby breech the password. With a virtual keypad approach the easily monitored keystrokes are replaced with hard to attack anonymous mouse clicks. The method is based on digitally scrambling the images that represent a keypad and randomly arranging them on the user screen. The user then clicks on the each image that represents the corresponding number or character in the password. For example, if a PIN is ‘1462’ the user will click on the key images of digits ‘1’, ‘4’, ‘6’, and ‘2’ in that order. No visual indication is provided on the screen that a particular image on the virtual keypad is clicked. Therefore, shoulder surfers cannot guess the password by following the mouse movement from a distance.

In a preferred embodiment, a standard web browser is used to display a virtual keypad for entering the user PIN on a display device connected to a host computer 105. A secure web server, e.g., one of the application programs 301, acts as an authentication server and generates the web pages for providing the secure login mechanism. The web server can be on an enterprise workstation of a service provider, e.g., on a remote computer 101′, or on a network smart card 101.

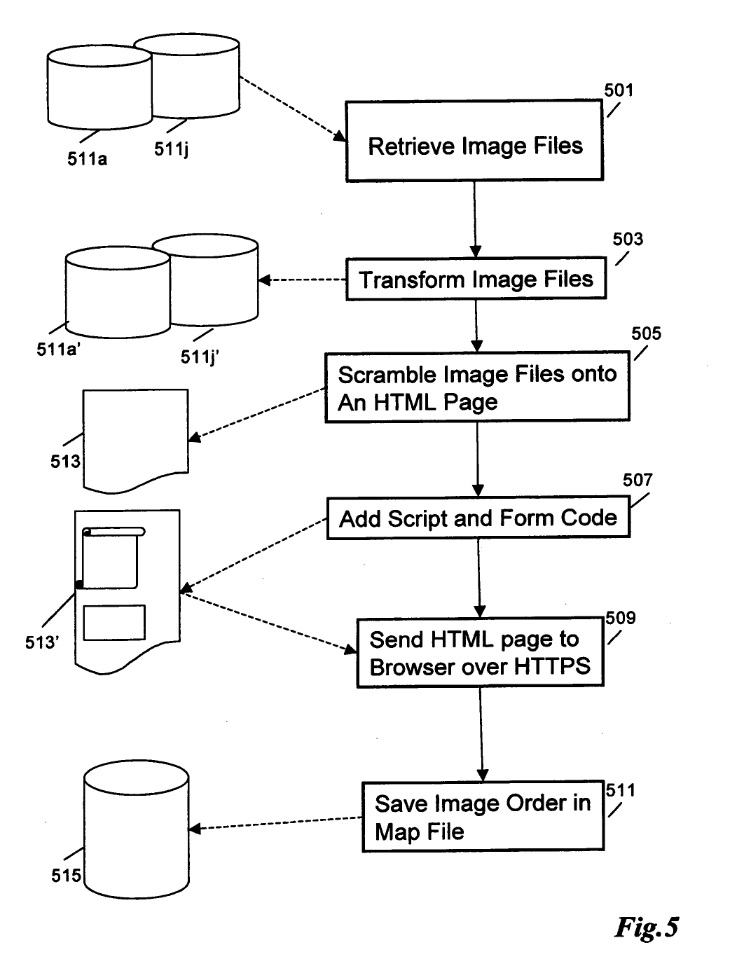

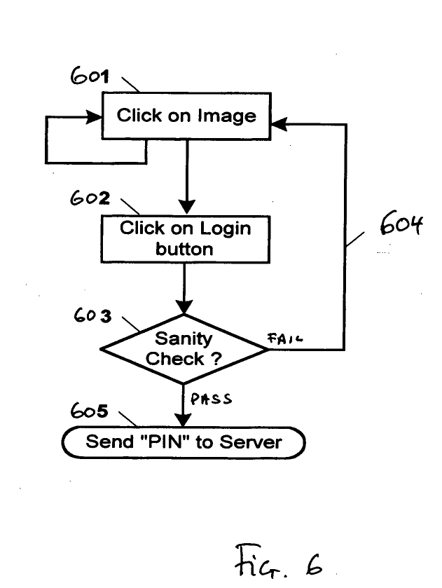

FIG. 5 is a flow-chart illustrating the method of generating and displaying a virtual keypad 403 to a user.

Step 501: Since a keypad for entering a numeric PIN consists of 10 keys (0 to 9) there is a corresponding number of image files 511a-j, one for each number, stored on the server, e.g., in the non-volatile memory 209. Each of these files contains an image of the digit it represents.

Step 503: In one embodiment of the invention, the images stored in these image files 511a-j are transformed using some random parameters. The transformation process may consist of one or more of the transformations selected from:
blurring the image
color shifting the image
tilting the image
cropping some corner areas of the image

The idea behind these transformations is to spoof any digital pattern recognition efforts by malicious software, while still preserving the visual recognition of image by human users. Next, the transformed image is written to a temporary area of NVM under a new name. For example, image 511a is transformed and saved as 511a′.

Step 505: The transformed images are placed on an HTML page 513 in a keypad layout. However, the order of images is randomly scrambled, as illustrated in FIG. 4. One way of doing this is to use a simple table layout that allows non-overlapping image arrangement, i.e., each image file is allowed a specified area and the areas are numbered, then laid-out according to a table defining their relative locations, e.g., for the example of FIG. 4 if each key is allowed 100×100 pixels the table may be as follows:

TABLE 1
Table of locations for keypad images to produce a random keypad.

| Digit | Location as Position | Location as Coordinates |
|---|---|---|
| 0 | 9 | 100, 400 |
| 1 | 5 | 100, 0 |
| 2 | 0 | 0, 0 |
| 3 | 2 | 0, 200 |
| 4 | 3 | 0, 300 |
| 5 | 8 | 100, 300 |
| 6 | 1 | 0, 100 |
| 7 | 6 | 100, 100 |
| 8 | 4 | 0, 400 |
| 9 | 7 | 100, 200 |

Table 1 shows the location of each image either as a sequential position from the first image, or as a coordinate. A RAM buffer is used to temporarily store this mapping of each image to its current rendered location.

Two alternative ways of placing the image files on the HTML page 513 include composing one image file from each of the individual image files and, alternatively, to have the HTML page 513 refer to each individual image file. In the second alternative an additional transformation is possible, namely, to randomize the file names of the individual image files, thereby making any inference from the file name impossible. Similarly, the image file containing a composite representation may also have a randomized file name to obscure that it contains a representation of keys used to enter an authorization phrase.

Step 507: A scripting code, e.g. in JavaScript, is added to the HTML page 513 producing an augmented HTML page 513′. This code captures the user selections on the client browser and creates a string representing the locations selected by the user. One way to handle this is by adding an onclick ( ) function for each image. The onclick ( ) function is called when user clicks on the image and captures the location of each such click. In addition, an HTML form is added so the user can submit the PIN selection. For purposes of example, a sample HTML page including the javascript code 517 and the HTML form code 519 may be found in Appendix A hereto. The code found in Appendix A produces a web page for example, like the one shown in FIG. 4.

The augmented HTML page 513′ includes:
JavaScript code to process user selection on the client browser.
Randomly arranged keypad of transformed images of the keypad digits.
An HTML form to submit the user selection to the web server (running on the server device 101).

Step 509: The augmented HTML page 513′ is transmitted to the web browser on the host computer 105 over a secure HTTPS connection.

Step 511: The RAM buffer used for creating this page can now be freed. However, the RAM buffer that holds the map of PIN numbers and their current location in the keypad needs to be saved. It is either kept in RAM, or if RAM space is scarce written to NVM or some other secondary storage.

The server side requirement for the methodology of this approach is that the server be able to support a secure HTTPS connection from the client.

Pin Entry

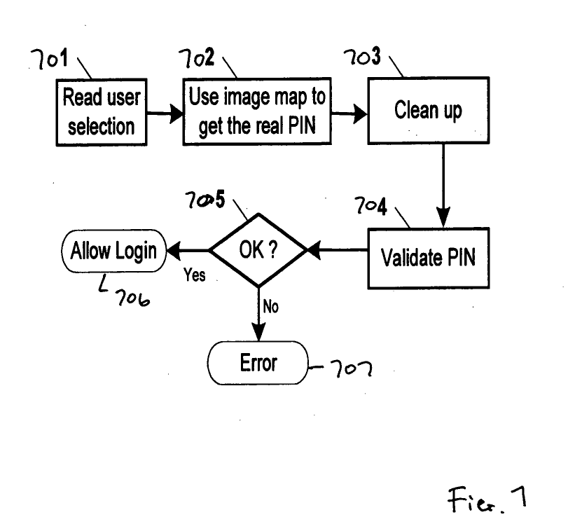

FIG. 6 is a flow chart illustrating a user's interaction with the augmented HTML page 513′ for the purpose of entering a PIN by using a web browser executing on the host computer 105. From the process illustrated in FIG. 5, the augmented HTML page 513′ has been transmitted to the host computer 105. A web browser executing on the host computer 105 causes the display of a window much like window 401 of FIG. 4 to be displayed on a display device of the host computer 105.

Step 601: The user positions a cursor and clicks on a number image displayed. This action produces no visual clue as to whether a number image was selected. Therefore, it is very hard for shoulder surfers to guess if a mouse click happened as the user moved his cursor over the image. However, the underlying scripting code has recorded the user selection of a given location in the keypad into an array for that purpose. This process can be repeated until the user has entered the complete PIN. In the example code of Appendix A, the array for recording the user selections is the data structure called “document.vpad.pw.value”.

If at any time while entering the PIN the user realizes that a mistake was made, the user may hit the “Clear” button 407 to clear the selection and start over.

Step 602: After the user has entered the PIN by clicking on the images of keys, the user clicks on the “Login” button 405.

Step 603: In one alternative embodiment, the clicking of the “login” button 405 may trigger some checking before sending the sequence of click locations to the server 101. Thus, clicking on the “login” 405 may invoke a function of the JavaScript code 517 that has been loaded as part of the augmented HTML page 513′ to do some sanity checks on the client web browser. For example, the user can be warned if the exact number of digits required for the PIN has not been entered. Since there is no visual indication to the user that a digit has been selected, this client side check can be useful.

Step 604: If the check fails, the array representing the current user selection is cleared and the user is asked to select the PIN again.

Step 605: If the check in step 3 succeeds, the array of selected number locations is sent to the web server on the server computer 101 as a POST message. The number locations can be sent either as sequential positions, or as coordinates.

PIN Processing

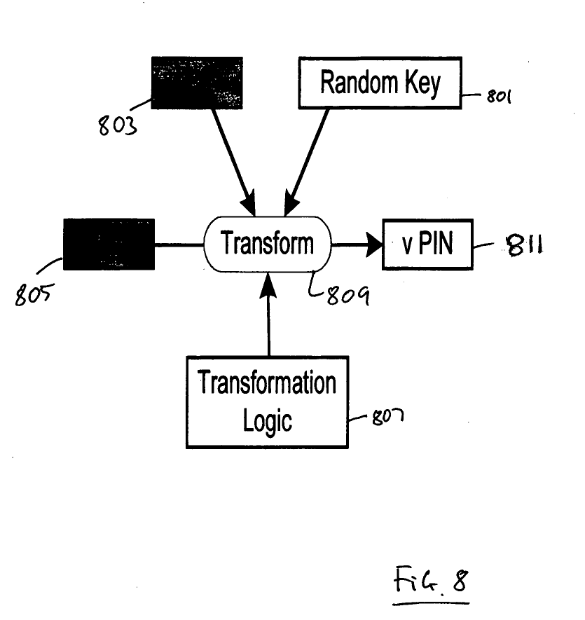

FIG. 7 is a flow-chart illustrating the actions taken by the web server executing on server computer 101 when processing the PIN sent from the browser.

Step 701: First the web server application reads and parses the array of selected user locations as selected by the user using mouse clicks in the procedure illustrated in FIG. 6. The array of selected number locations is sent as an data of the POST method.

Step 702: Next the web server application use the image map saved as part of step 511 of the procedure illustrated in FIG. 5 to convert the selected image locations to actual PIN numbers. For example using the example of Table 1, if the array of user-selected locations are ((150,350), (80,450), (60,82), (120,290)) the corresponding PIN would be 5829. The result from this mapping operation represents the actual PIN entered by the user. Another option is to send back the user selection location not as coordinates, but as image positions in the keypad 403. For example, selection location can be 8407, which would translate into a PIN of 5829. Table 1 shows an example of the relationship between actual number and its location shown both as position and coordinate.

Step 703: Once the actual PIN has been derived using the map file, the web server application cleans up the temporary buffers from both RAM and NVM. This includes reinitializing the RAM memory used for image map, and deleting all the transformed image files from the underlying file system.

Step 704: Next the web server application compares the actual PIN with the PIN stored in the server 101, e.g., the server being, for example, a network smart card. In one embodiment the comparison is actually done by first generating a one-way hash of the PIN and then comparing the hash value against that stored in user's password file.

Step 705: Finally, the web server application 301″ checks the results of the comparison. If PIN matches, the user is granted access 706, otherwise access is denied and an error page is sent back, step 707.

In one embodiment of the invention, for example as illustrated in Appendix A, each image on the HTML page is a link to a randomized file name. By randomizing the file names, it makes it harder for mal-ware installed on the host computer 105 to detect the files associated with various images. From a performance point of view, this may result in very slow rendering of the login page because each image may require a separate round-trip to the authentication server 301. While that approach may work for a numeric keypad, it could be impractically slow for alphanumeric keypads. In an alternative embodiment, to speed up the display of login page, one design option is to roll all separate images into a single image before sending to the browser. Now the user selection is recorded in the form or image X-Y coordinates. Upon receipt of the locations from the host computer 105, the authentication server 301 then parses these coordinates to determine which image was selected.

Transformation Approach to One-Time Password

In alternative embodiments the randomized image of numbers transmitted from the web server application 301 is not used to select a PIN but rather it is used as an operand in one of several transformation operations that may be used to indicate the user's PIN. In these embodiments the user applies a mathematical transformation to the PIN that user has memorized. The transformation is keyed off some sequence of random numbers that are displayed on the login page. The result of this transformation, a virtual PIN (abbreviated as vPIN below), that can be used as a one-time password (OTP).

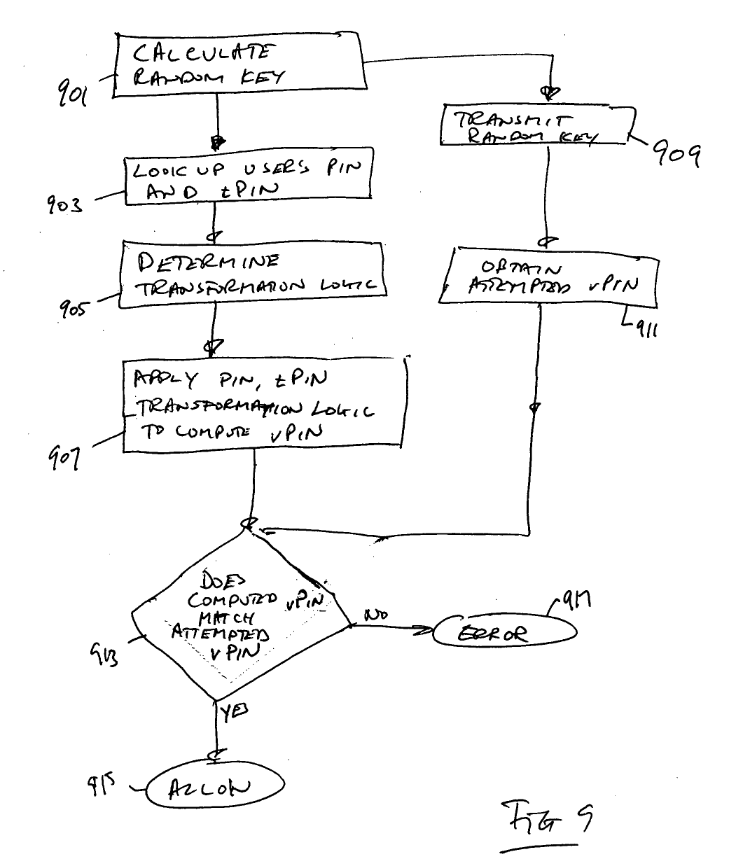

FIG. 8 is a schematic illustration of the relationship between a random number key 801 transmitted from the server 101 to the host computer 105 for display to the user, a transformation PIN (tPIN) 803, the user's PIN 805, a transformation logic 807, a transformation operation 809 and the resulting vPIN 811. The random number key 801, the tPIN 803, the PIN 805, and the transformation logic 807 are inputs to a transformation operation 809 performed by the user to calculate the vPIN 811. The random number key 801 is generated by the web server application 301 and transmitted to the web browser on the host computer 105 for each new attempt by the user to log in to the server. Thus, the vPIN will be different for each attempted use by the user and can be considered a one-time password and is therefore not prone to compromise by snooping or shoulder surfing.

Of the four inputs the user has to remember the PIN 805 and the tPIN 803. Depending on the level of security desired by the user or by the overall security scheme, to make it easier for the user to remember both these numbers, the PIN 805 and tPIN may be selected to be identical or some easy function of one another, e.g., the tPIN being the reverse of the PIN.

The transformation logic may either be a public well-known formula or a proprietary authentication server specific formula. In the case of a public well-known formula, the transformation logic may be explained to the user on the log in screen.

The transformation logic can vary in complexity depending upon the security requirement or the comfort level of the user. The logic can be designed in such a way that the selection of a particular transformation PIN can nullify the transformation effect. In this case the virtual PIN is the same as the actual PIN.

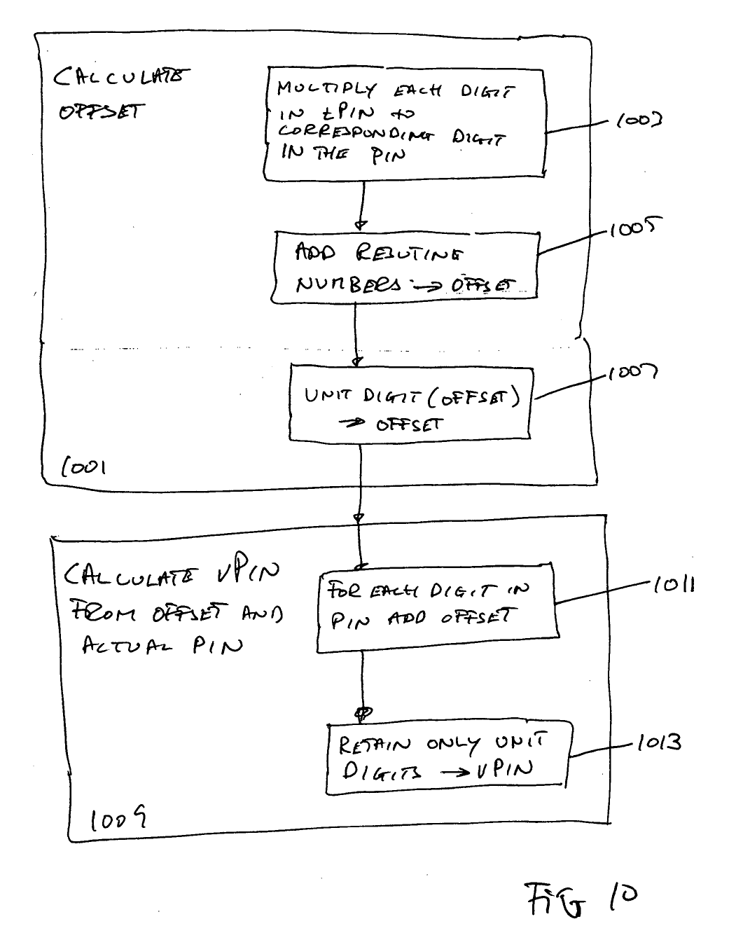

FIG. 9 is a flow-chart illustrating the general approach by the authentication server 301 to use the random key approach of the present invention to generate and verify a one-time password vPIN.

Step 901: The random number key 801 is generated by the authentication server 301. Step 903: The user's PIN and tPIN are determined. The PIN determination process can be as simple as reading the PIN and tPIN from the user profile on authentication server 301.

Step 905: The transformation logic to be used is determined. There are many different ways to select transformation logic to be used. For example, the transformation logic may be part of the user profile, or preference on server 301.

Step 907: The PIN, tPIN, and random number key are applied to the transformation logic to determine the vPIN that should be expected from the user.

Step 909: In parallel with these steps to determine the expected vPIN, the random number key 801 is transmitted to the web browser on the host computer 105. Where it is displayed to the user on the web browser login screen. The process by which the user uses the random number key 801 is discussed herein below.

Step 911: At this stage the authorization server waits for and receives the attempted vPIN to be transmitted from the client host computer 105.

Step 913: The attempted vPIN from step 911 and the determined vPIN from step 907 are compared. If they match, the user is allowed access, step 915. Otherwise, an error message 917 is displayed for the user.

### TRANSFORMATION EXAMPLE I

The first example of formula-based transformation uses addition and multiplication to transform the PIN 805 into an OTP, the vPIN 811. Since it is the vPIN that is entered, and not the actual PIN, the latter is not compromised. There are two things that are kept secret by the user, a PIN, and a transformation PIN (tPIN). The PIN can be a regular four-digit number that is represented as P₁P₂P₃P₄ (e.g. 2459), and the transformation key can be a two-digit number represented as T₁T₂ (e.g. 13). The login screen that asks the user to enter the PIN for authentication will provide a random number. In this example the random number is a two-digit number represented by R₁R₂ (e.g. 46), which is transmitted from the authentication server 301 to the host computer 105 in step 909. On the client side, the random number key 801 is displayed on the web browser.

The mathematical transformation to convert the PIN into a virtual PIN that is represented by V₁V₂V₃V₄ is executed using two steps. Note: these steps are carried out both by the user who seeks to enter a correct vPIN and the authentication server 301 that determines whether the correct PIN has been entered by the user.

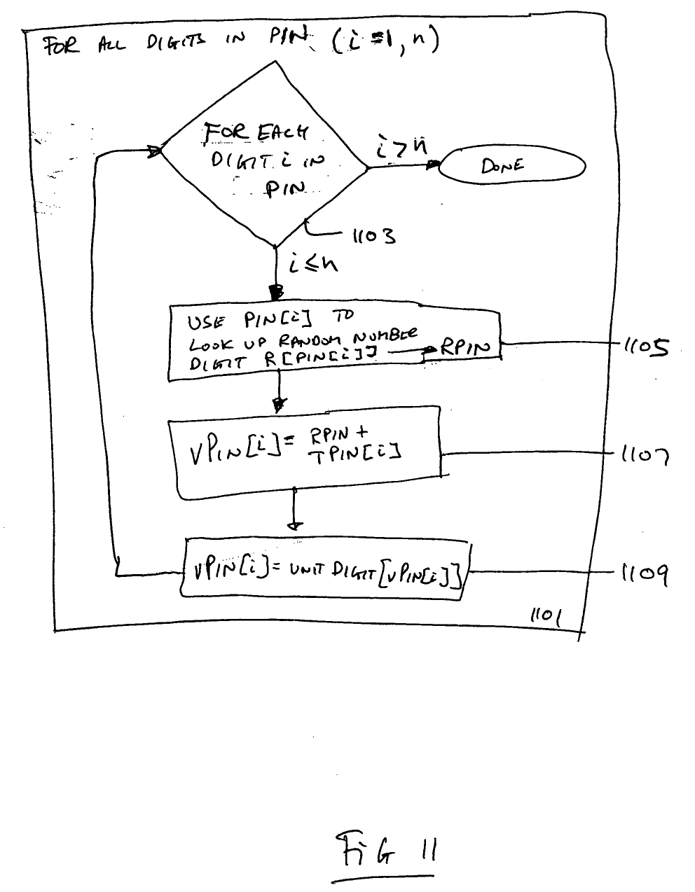

FIG. 10 is a flow-chart illustrating the steps taken by the authentication server 301 to compute the expected vPIN and by the user to compute the vPIN for entry.

Step 1. Use the transformation key T₁T₂, and the random number R₁R₂ to get a conversion offset, step 1001. First each digit of the random number is multiplied with the corresponding digit of the transformation PIN, Step 1003. The resulting numbers are then added (and saved temporarily as offset), Step 1005. The unit digit of this new number is determined, Step 1007. This is the offset, and it can have any value between 0 and 9.

Mathematically the logic is represented as:

TABLE 2
Mathematical calculation of offset

offset = (R₁ * T₁) + (R₂ * T₂)
while (offset > 9)
{
offset = offset − 10
}

Using the aforementioned example values of random number and the transformation PIN, the offset is calculated as follows:

TABLE 3
Example calculation of offset

offset = (4 * 1) + (6 * 3)
offset = 22
offset = 2

Step 2. Compute the vPIN from the PIN and the offset, Step 1009. The conversion offset from step 1 is added to each digit of the actual PIN to get the corresponding digit of the virtual PIN, Step 1011. In case the resulting digit is greater than 9, only the unit digit (the right most digit) is kept, Step 1013.

TABLE 4
Mathematical calculation of vPIN using PIN and offset

V₁ = P₁ + offset
V₂ = P₂ + offset
V₃ = P₃ + offset
V₄ = P₄ + offset

In each computation of the virtual PIN digit, only the unit digit is used. For example:

TABLE 5
Example calculation of vPIN using a known PIN and calculated
offset.

V₁ = 2 + 2 = 4
V₂ = 4 + 2 = 6
V₃ = 5 + 2 = 7
V₄ = 9 + 2 = 11 = 1

Thus, in the example, the final virtual PIN, V₁V₂V₃V₄ is 4671. This is the PIN that is entered at the login page and used by the authorization server 301 to verify that the correct vPIN was entered.

### EXAMPLE TWO

### Random Index Transformation from PIN to vPIN

A second approach using a transformation approach to determine a vPIN uses a simpler transformation logic that is based on a single arithmetic computation: addition. This logic is easier to compute as compared to the first example. The user remembers two secrets; a PIN represented by P₁P₂P₃P₄ (e.g. 2459) and a transformation PIN represented by T₁T₂T₃T₄ (e.g. 3576). The login page displays a 10 digit random number that is indexed from 0 to 9. The index of each digit is shown on top of the random digit for easy identification. For example:

TABLE 6
Example of Random Index for use with Random Index
Transformation

| | Index | | | | | | | | | |
|---|---|---|---|---|---|---|---|---|---|---|
| | 0 | 1 | 2 | 3 | 4 | 5 | 6 | 7 | 8 | 9 |
| Random Number | 5 | 7 | 1 | 0 | 6 | 2 | 9 | 1 | 4 | 3 |

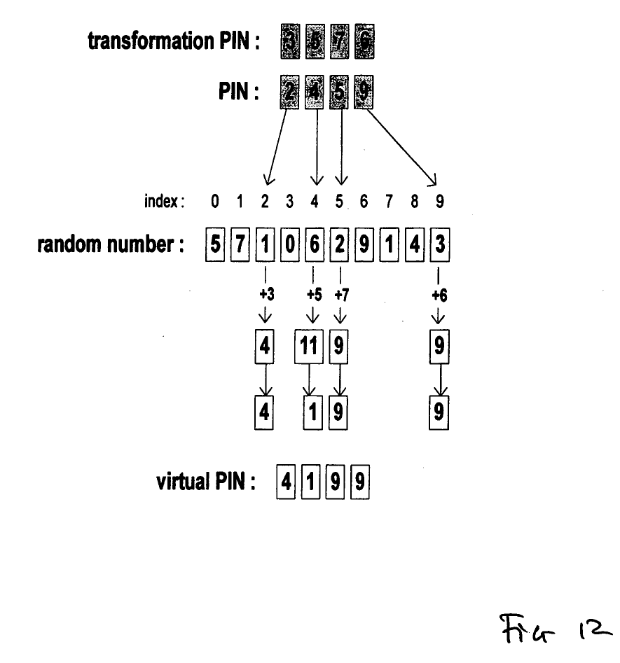

FIG. 11 is a flow-chart illustrating the use of the random-index transformation method for computing the vPIN from the PIN, tPIN, and a random number provided by the authorization server 301.

For each digit in the PIN, call it digit i, Step 1103, take that digit of the PIN (in aforementioned example, PIN is 2459, so the first digit is 2) and use this first digit as an index to get the corresponding digit in the random number, Step 1 105. Call the RPIN. For the first digit in the PIN in the example, the index value is 2, the corresponding random number (RPIN) is 1.

Next, add the random number, RPIN, (i.e., from the example, RPIN=1) to the corresponding digit of transformation PIN, Step 1107. In the example, the transformation PIN is 3576, the first digit is 3. Therefore, the first digit of virtual PIN is 1+3=4.

If the resulting vPIN digit is greater than 9, only the unit digit is used, Step 1109.

Repeat steps 1105, 1107, and 1109 for the remaining digits in the PIN until all digits of the PIN has been processed.

Using this logic, with a random number array of ‘5710629143’, a PIN of 2459, and a tPIN of 3576, the virtual PIN V₁V₂V₃V₄ comes out to be 4199. It is this number that is entered when logging into the system instead of the original PIN. The transformation calculations are:

TABLE 7
Example using PIN as index transformation

V₁ = 1 + 3 = 4
V₂ = 6 + 5 = 11 = 1
V₃ = 2 + 7 = 9
V₄ = 3 + 6 = 9

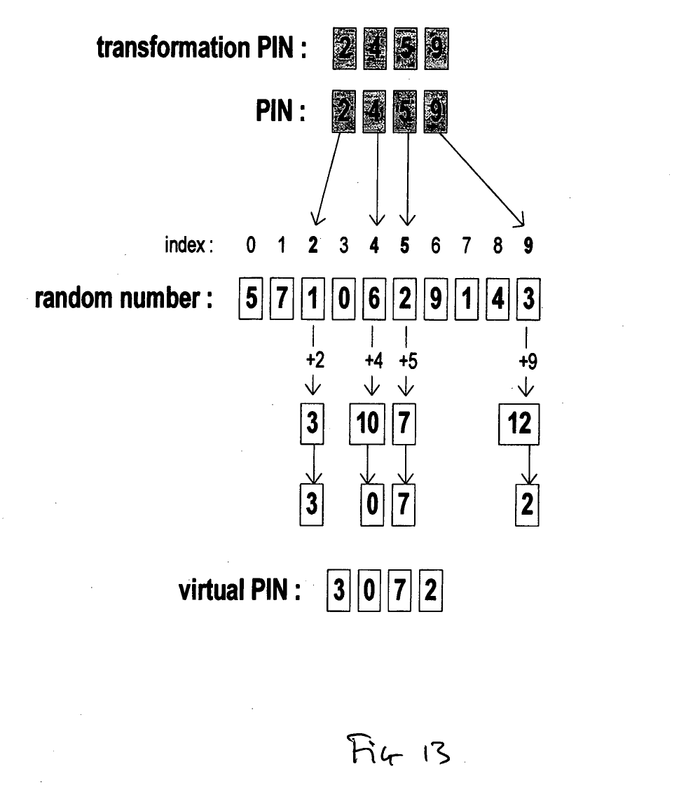

FIG. 12 is a graphical illustration of the above described example.

A further simplification of this logic can be done when selecting the transformation PIN. If all four digits of the transformation PIN are the same, the user only has to remember one digit, which is added to the random numbers. This speeds up the computation required to transform the PIN into a virtual PIN. Similarly, if all the digits of the transformation PIN are ‘0’, there is no need for addition. The transformation process then becomes a simple use of the index to lookup the corresponding digit in the random number array.

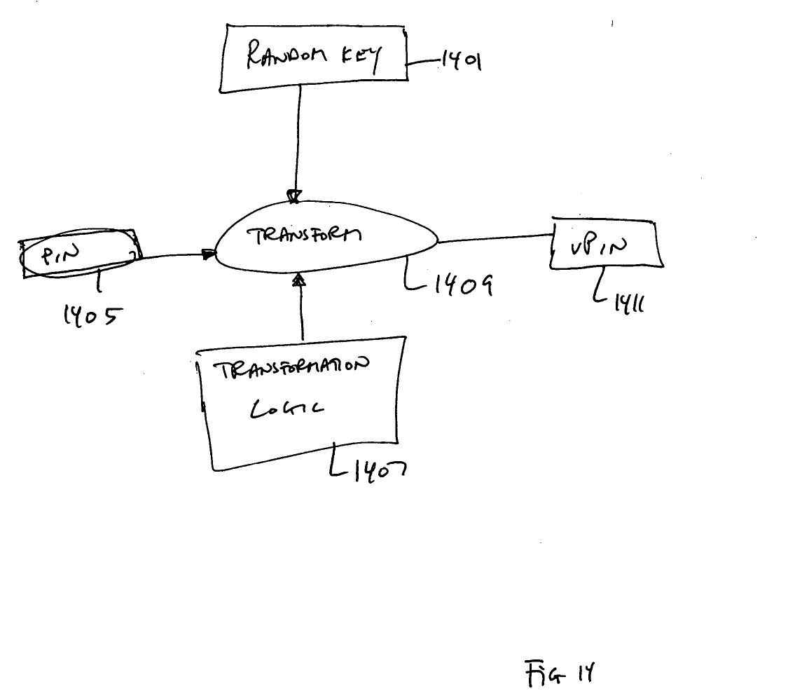

FIG. 13 is a graphical illustration of yet another variation to this embodiment of the invention in which the PIN and tPIN are identical. The user now has to remember only one PIN. The task of addition also becomes simpler. This is because the two numbers to be added are vertically aligned: random number and the index.

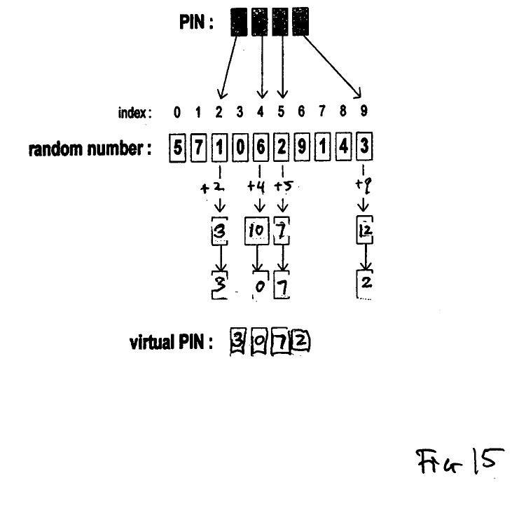

The embodiments described in conjunction with FIGS. 8 through 13, which include methods using both a PIN and a tPIN, may be generalized to only use a PIN and a random number transmitted from the authentication server 101. FIG. 14 is a schematic illustration of an embodiment of the invention in which a user only needs to remember a PIN and to use it in conjunction with a random key to derive a vPIN. As in the previously discussed examples, a random key 1401 is generated by the authentication server 101 and transmitted to the host computer 105. The user uses that random key and the PIN 1405 and a defined transformation logic 1407 to perform a transformation operation 1409 to obtain the vPIN 1411.

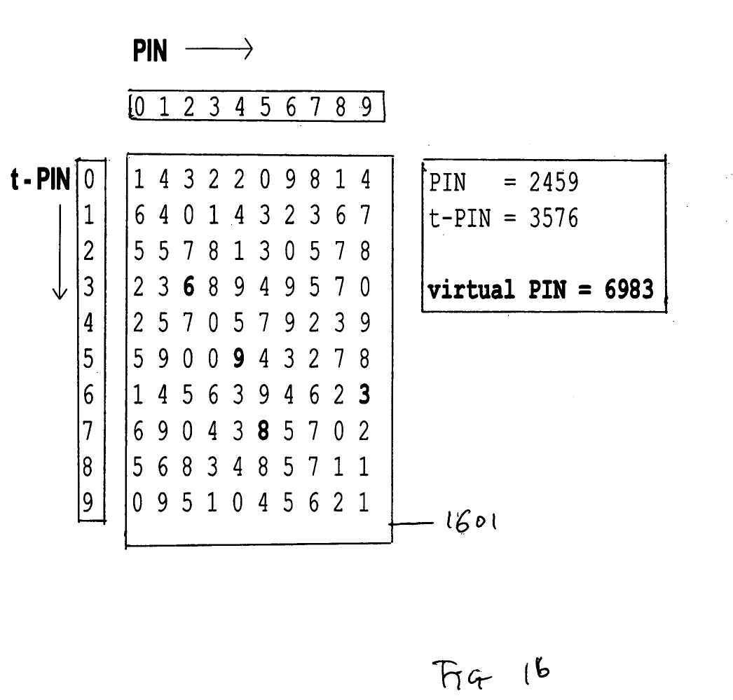

FIG. 15 is a schematic illustration of an example in which a user only uses a PIN 1405 and a random number 1401 to generate the vPIN 1411. In this example, the transformation logic 1407 is to first use the PIN digits as indexes in the random number 1401 to look up the corresponding digit in the random number 1401. Second that looked-up digit is added to the corresponding PIN digit to arrive at the vPIN 1411.

For the first digit, the PIN digit is 2. The corresponding random number digit (in the 2-position) is 1. Adding that number (1) to the PIN digit (2) results in the value 3, which will be the first digit in the vPIN. Continuing in this fashion for the remaining digits, a vPIN of 3072 results.

### EXAMPLE 3

### Use of Matrix in Transformation from PIN to vPIN

In an alternative embodiment, the transformation logic rather than generating and transmitting a random number, a matrix of random numbers is generated by the authentication server 301 and transmitted to the host computer 105 for display on the login window. This embodiment removes the overhead of addition. Rather than adding two numbers, the user simply picks a number from the pre-computed matrix. The authentication server 301 generates a 10×10 matrix. The PIN is represented along columns, while transformation PIN is represented along rows.

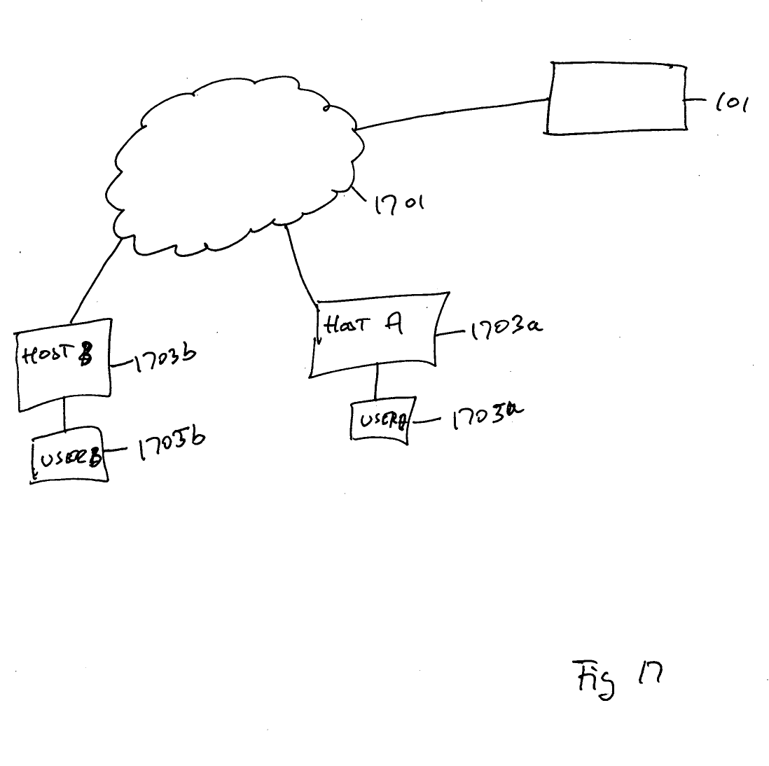

FIG. 16 is a graphical illustration of a transformation matrix used in this embodiment of the invention.

Each cell in the matrix 1601 is generated by computing the following transformation:

TABLE 8
Formula for Calculating the Value of Matrix Cells

Cell_{i,j} = (R [i] + j ) mod 10

wherein R is an array representing a ten-digit random number transmitted from the authentication server 301 to the web browser on the host computer 105.

Since the user does not perform the additions manually, random number array R does not have to be displayed at the login page. Instead the resulting matrix is displayed. In one embodiment, the html page includes some code for computing the matrix from the random number array. The matrix can either be generated at the authentication server 101, or at the client browser. In the first case the HTML code only displays the matrix; it does not compute it. In the second case Javascript code, transmitted with the HTML code, causes the computation of the matrix using the random number. In both cases the user does not see the random number. The HTML page transmitted from the authentication server 301 includes the requisite code to produce a matrix using the transformation.

In the example of FIG. 16, using the matrix 1601 a PIN value of 2459 and a transformation PIN value of 3576 translates into a virtual PIN value of 6983. This number is picked as follows:

The intersection of row 3, column 2 gives 6.

The intersection of row 5, column 4 gives 9.

The intersection of row 7, column 5 gives 8.

The intersection of row 6, column 9 gives 3.

While the example of FIG. 16 uses tPIN and PIN as indexes to obtain a PIN from the matrix 1601, in an alternate embodiment the random number transmitted from the authentication server 301 is used in lieu of TPIN as one of the indexes.

The background color of alternate rows/columns can be contrasted to help user locate the intersection cell.

### Two-User Embodiment

In an alternative embodiment of the invention the tPIN and PIN are known by two different users. Thus, to obtain access to a protected service, both users must agree much in the same fashion as two authorized individuals may be required to use separate keys to obtain access to a safe protected by two locks; each has his own key and without both keys neither obtains access.

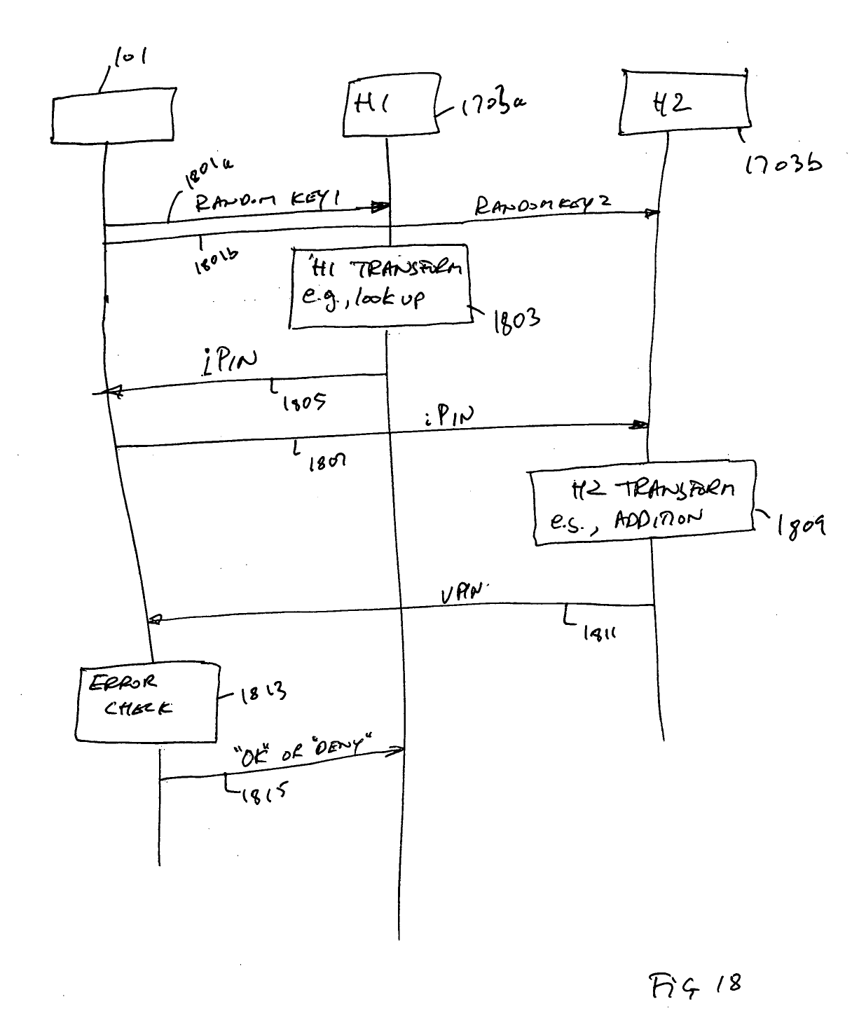

FIG. 17 is a schematic illustration of a network scenario in which two different users possess the PIN and tPIN, respectively to obtain access to a service protected by the authentication server. The authentication server 101 is connected to a network 1701. Two host computers, a first host computer A 1703a and a second host computer B 1703b are also connected to the network 1701. User A 1705a, who is operating host A 1703a is in possession of the PIN and User B 1705b is in possession of the tPIN.

FIG. 18 is a sequence diagram illustrating one possible dataflow and operations performed by the host A 1703a, the host B 1703b, and the authentication server 101 to perform authentication of the two users to allow access to a resource. The authentication server 101 transmits random keys 1 and 2 to the two hosts 1703a and 1703b, respectively, steps 1801a and 1801b. The user operating on the host A 1703a performs a first operation, e.g., a look-up operation, to obtain an intermediate quantity, the iPIN. step 1803. The iPIN is transmitted back to the authentication server 101, step 1805. Alternatively, not shown, the iPIN is transmitted from the host A 1703a to the host B 1703b.

The iPIN is then transmitted to the host B 1703b, which is operated by user B, step 1807. Alternatively, the authentication server first performs some manipulation of the iPIN before transmitting it to the host B 1703b to further obscure the PIN. The user B then performs a second transformation, e.g., adding the tPIN to the iPIN, step 1809, to obtain an attempted vPIN, which is transmitted back to the authentication server 101, step 1811.

The authentication server 101 then performs an check to determine if the attempted vPIN corresponds to the authorized vPIN, step 1813, and either allows access or denies access, step 1815.

Thus, two users who are in possession of separate authorization numbers, PIN and tPIN, respectively, can cooperate to obtain access to a resource without revealing their respective numbers to each other and without having these numbers revealed to mal-ware, or persons who are attempting to discern these numbers by looking over the user's shoulder.

From the foregoing it will be appreciated that method and system for secure login of the present invention provides an efficient and secure method of entering PINs and passwords whereby the actual values are never exposed. What might be revealed to malicious software are the locations picked by the user attempting to login. However, the malicious software cannot easily determine the digit corresponding to that image location.

Although specific embodiments of the invention have been described and illustrated, the invention is not to be limited to the specific forms or arrangements of parts so described and illustrated. The invention is limited only by the claims.

APPENDIX A
Example Source Code for the Augmented HTML page
513′

```
<!--------- BEGIN Script ------------>
<script language=“javascript”>
/* Global variable to store the number of clicks */
var pinCount=0
/* Function to handle each mouse click on the keypad */
function click(data)
{
  if (pinCount==4)
  {
    /* Do not allow more than 4 clicks, one for each digit.
*/
    alert(“Warning: PIN data already complete. Please Login,
or Clear to re-PIN”)
    return
  }
  /* Append the PIN count, and the PIN array */
  pinCount=pinCount+1
  document.vpad.pw.value += data
}
/* Function to handle the PIN submission */
function done( )
{
  /* Sanity check. Do not submit if 4 PIN have not been
selected */
  if (pinCount<4)
  {
    alert(“Incomplete PIN: only “ + pinCount + ” of 4 digits
selected”)
    return
  }
  /* Reset the PIN count, and submit the current selection */
  pinCount=0
  document.vpad.submit( )
}
/* Function to clear the current user selection */
function clearPIN( )
{
  document.vpad.pw.value = “”
  pinCount=0
}
/* Function to display an error message to user */
function errorHandler(message, url, line)
{
  alert(“JScript Warning: ”+message)
  return true
}
window.onerror = errorHandler
</script>
<!--------- END Script ------------>
<!--------- BEGIN HTML data ------------>
<html><head><title>Axalto Web ID Card</title>
<style>
td {font-family:Helvetica;font-size:small}
td.c3 {font-size:1.0em;font-weight:bold;color:#9b4490}
</STYLE>
</head>
<body>
<div align=“center”>
<!--------- BEGIN Form data ------------>
<FORM id=vpad name=vpad action=“../cgi-bin/login” method=post>
<br>
<img SRC=“images/axaltol.gif”>
<TABLE width=400>
<TR> <TD class=c3 align=center><b>Axalto Web Identity Card:
Login</b>
<br>
<hr width=400 color=#9b4490>
</TD></TR>
<TR> <TD align=center> To gain secure access to your Web Identity
Card select your
PIN by clicking on the keypad below, and then click on the Login
button. <br><br>You may click Clear
button to discard current clicks. </TD></TR>
</TABLE>
<br>
<TABLE cellSpacing=2 cellPadding=2>
<TR>
<TD align=middle><a href=“javascript:click(‘0’)”><img
src=“images/num_rp.gif” border=0></a></TD>
<TD align=middle><a href=“javascript:click(‘1’)”><img
src=“images/num_eu.gif” border=0></a></TD>
<TD align=middle><a href=“javascript:click(‘2’)”><img
src=“images/num_ty.gif” border=0></a></TD>
<TD align=middle><a href=“javascript:click(‘3’)”><img
src=“images/num_yc.gif” border=0></a></TD>
<TD align=middle><a href=“javascript:click(‘4’)”><img
src=“images/num_xx.gif” border=0></a></TD>
</TR>
<TR>
<TD align=middle><a href=“javascript:click(‘5’)”><img
src=“images/num_rl.gif” border=0></a></TD>
<TD align=middle><a href=“javascript:click(‘6’)”><img
src=“images/num_yu.gif” border=0></a></TD>
<TD align=middle><a href=“javascript:click(‘7’)”><img
src=“images/num_aa.gif” border=0></a></TD>
<TD align=middle><a href=“javascript:click(‘8’)”><img
src=“images/num_kk.gif” border=0></a></TD>
<TD align=middle><a href=“javascript:click(‘9’)”><img
src=“images/num_dp.gif” border=0></a></TD>
</TR>
</TABLE>
<br>
<input type=button value=Clear onclick=“javascript:clearPIN( )”>
<input type=button value=Login onclick=“javascript:done( )”>
<input type=hidden name=nm value=“jsmart”>
<input type=hidden name=pw size=10>
<input type=hidden name=md value=“P”>
<hr width=400 color=#9b4490>
</div>
</form>
<!--------- END Form data ------------>
</body>
<!--------- END HTML data ------------>
```

We claim:

1. A method for authenticating a user for use of a server computing device wherein the server computing device is connected by a network to a host device, comprising:
in response to a request to access the server computing device, generating on the server computing device a key representation image having thereon a plurality of individual key images placed at random positions, each corresponding to a possible character value in an authentication phrase;
transmitting the key representations to the host device using a network protocol;
receiving a sequence of location values from the host device transmitted using a network protocol, where the sequence of location values correspond to locations of mouse clicks representing user selections of character values in an attempted authentication phrase; and
verifying that the sequence of location values corresponds to a correct authentication phrase by mapping the locations of the mouse clicks to the locations of the randomly placed key images.

2. The method of authenticating a user of claim 1 wherein the authentication phrase is a personal identification number (PIN) and the possible character values represent an alphabet of possible values for characters that may compose the PIN.

3. The method for authenticating a user of claim 1, wherein the authentication phrase is a password and the possible character values represent an alphabet of possible values for characters that may compose the password.

4. The method for authenticating a user of claim 1, wherein the generating step comprises:
retrieving an image from an image file for each possible key stroke;
creating the keypad representation by placing the image files in a scrambled order on the keypad representation.

5. The method for authenticating a user of claim 1, wherein the keypad representation is an html page and the step of creating further comprises adding a script and form code to the html page representation wherein the script code is operable to capture user selections on a client browser executing on the host and to create from those selections a string representing the selections made by a user.

6. The method for authenticating a user of claim 1, wherein the generating step comprises:
retrieving an image from an image file for a possible key stroke;
transforming at least one image of the retrieved images.

7. The method for authenticating a user of claim 6, wherein the transforming step comprises at least one transformation selected from blurring the image, color shifting the image, tilting the image, and cropping some corner areas of the image.

8. The method for authenticating a user of claim 1, wherein the generating step comprises:
producing a randomized name for a file containing the key representation prior to transmitting the key representation to the host device.

9. The method for authenticating a user of claim 1 wherein in the step of receiving a sequence of location values from the host device to the server computing device using a network protocol, the network protocol is a secure network protocol.

10. The method for authenticating a user of claim 9 wherein the secure network protocol is TLS or SSL.

11. The method for authenticating a user for use of a server computing device of claim 1 wherein the network connection between the server computing device and the host device uses a secure network protocol, such as TLS or SSL.

12. The method for authenticating a user of a server computing device of claim 1 wherein the server computing device is a smart card.

13. A method for authenticating a user for use of a server computing device wherein the server computing device is connected to a host device, comprising:
in response to a request to access the server computing device, generating on the server computing device a random number;
transmitting the random number to the host device using a network protocol;
receiving from the host device a sequence of values corresponding to an attempted authentication phrase transmitted using a network protocol; and
verifying that the authentication phrase corresponds to an authorized authentication phrase wherein the authorized authentication phrase is a function of an authorized user's personal identification number (PIN) and the random number.

14. The method of authenticating a user for use of a server computing device of claim 13 wherein the step of transmitting from the host device to the server computing device uses a secure network protocol.

15. The method of authenticating a user of claim 14 wherein the secure network protocol is selected from the set including TLS and SSL.

16. The method of authenticating a user of claim 13 wherein the function requires a numerical manipulation based on the PIN and the random number.

17. The method of authenticating a user of claim 13 further comprising:
in response to a request to access the server computing device, generating on the server computing device a key representation image having thereon a plurality of individual key images placed at random positions, each corresponding to a possible character value in an authentication phrase;
transmitting the key representations to the host device using a network protocol; and
wherein the step of transmitting a sequence of values corresponding to an attempted authentication phrase further comprising registering a user's mouse clicks on the key images;
receiving a sequence of location values from the host device transmitted using a network protocol, where the sequence of location values correspond to locations of mouse clicks on the key images and representing user selections of character values in an attempted authentication phrase; and
verifying that the sequence of location values corresponds to a correct authentication phrase by mapping the locations of the mouse clicks to the locations of the randomly placed key images.

18. The method of authenticating a user of claim 13 wherein the server computing device is a smart card.

19. A method for operating a server computing device to authenticate a user wherein the server computing device is connected to a host device, comprising:
in response to a request to access the server computing device, generating on the server computing device a random number;
transmitting a quantity that is a function of the random number to the host device using a network protocol;
receiving from the host device a sequence of values corresponding an attempted authentication phrase; and
verifying that the authentication phrase corresponds to an authorized authentication phrase wherein the authorized authentication phrase is a function of an authorized user's personal identification number (PIN) and the random number.

20. The method of claim 19 wherein the transmitted quantity is a random number and the matrix generated from another random number.

21. The method of claim 19 wherein the transmitted quantity is a random number and a script to generate a matrix from the random number.

22. The method of claim 20 wherein the matrix is generated using the formula:
cell[i,j]=(random number [i]+j) mod 10.

23. The method of claim 19 wherein the transmitted quantity is the random number and a script operable to generate a matrix from the random number using the formula:
cell[i,j]=(random number [i]+j) mod 10.

24. The method of claim 19 wherein the network protocol is a secure network protocol such as TLS or SSL.

25. The method of claim 19 wherein the secure computing device is a smart card.

26. A method for authenticating a user for use of a server computing device wherein the server computing device is connected to a host device, comprising:
in response to a request to access the server computing device, generating on the server computing device a random number;
transmitting the random number to the host device using a network protocol;
receiving from the host device a sequence of values corresponding to an attempted authentication phrase transmitted using a network protocol; and
verifying that the authentication phrase corresponds to an authorized authentication phrase wherein the authorized authentication phrase is a function of an authorized user's personal identification number (PIN), a transformation personal identification number (tPIN), and the random number.

27. The method of authenticating a user of claim 26 wherein the function requires a numerical manipulation based on the PIN, the tPIN, and the random number.

28. The method of authenticating a user of claim 26 further comprising:
in response to a request to access the server computing device, generating on the server computing device a key representation image having thereon a plurality of individual key images placed at random positions, each corresponding to a possible character value in an authentication phrase;
transmitting the key representations to the host device using a network protocol; and
wherein the step of transmitting a sequence of values corresponding to an attempted authentication phrase further comprising registering a user's mouse clicks on the key images;
receiving a sequence of location values from the host device transmitted using a network protocol, where the sequence of location values correspond to locations of mouse clicks on the key images and representing user selections of character values in an attempted authentication phrase; and
verifying that the sequence of location values corresponds to a correct authentication phrase by mapping the locations of the mouse clicks to the locations of the randomly placed key images.

29. The method of authenticating a user of claim 26 wherein the function uses the random number and the tPIN to produce an offset and authorized authentication phrase corresponds to the offset being applied to the PIN.

30. The method of authenticating a user of claim 26 wherein the random number is generated for each attempted access by a user.

31. The method of authenticating a user of claim 26 wherein the random number is a multi-digit number and the authorized authentication phrase is computed by a process that comprises successive lookup of digits in the random number using the digits in the PIN as index values.

32. The method of authenticating a user of claim 31 wherein the process to compute the authorized authentication phrase further comprises transforming a looked-up digit using a corresponding digit in the tPIN.

33. The method of authenticating a user of claim 26 wherein the transforming step includes adding the looked-up digit and the corresponding digit in the tPIN thereby computing a corresponding digit in the authorization phrase.

34. The method of authenticating a user of claim 26 wherein the secure computing device is a smart card.

35. A method for authenticating a user for use of a server computing device wherein the server computing device is connected to a host device, comprising:
in response to a request to access the server computing device, generating on the server computing device a random matrix;
securely transmitting the random matrix to the host device using a secure network protocol;
receiving from the host device a sequence of values corresponding an attempted authentication phrase; and
verifying that the authentication phrase corresponds to an authorized authentication phrase wherein the authorized authentication phrase is a function of an authorized user's personal identification number (PIN), a transformation personal identification number (tPIN), and the random matrix.

36. The method for authenticating a user of claim 35 wherein the authorized authentication phrase is determined by using the PIN digits and tPIN digits as indexes in the matrix and the corresponding authorized authentication phrase digit is the value at the matrix cell indexed by the PIN and tPIN digit.

37. The method for authenticating a user of claim 36 further comprising computing a random number having multiple digits and wherein each matrix cell is computed from the formula including the random number.

38. The method for authenticating a user of claim 36 further comprising computing a random number having multiple digits and wherein each matrix cell is computed from the formula including the random number:
cell[i,j]=(random number [i]+j) mod 10.

39. The method for authenticating a user of claim 35 wherein the secure computing device is a smart card.

40. A method for authenticating a user for use of a server computing device wherein the server computing device is connected to a first host device and a second host device, the method requiring a first user to be in possession of a personal identification number and a second user to be in possession of a transformation personal identification number, comprising:
in response to a request to access the server computing device, generating on the server computing device a first random number;
securely transmitting the first random number to the first host device using a secure network protocol;
receiving from the first host device a sequence of values corresponding to a first user's attempt at a transformation using the PIN and the first random number;
transmitting a second random number to a second host device and a sequence of numbers corresponding to the sequence of values entered by the first user;
receiving from the second host device a sequence of values corresponding to a second user's attempt at a transformation using the tPIN, the second random number and the sequence of numbers corresponding to the sequence of values entered by the first user; and
verifying that the sequence of values corresponding to the second user's attempt corresponds to an authorized authentication phrase wherein the authorized authentication phrase is a function of an authorized personal identification number (PIN), a transformation personal identification number (tPIN), the first random number and the second random number.

41. The method for authenticating a user of claim 40 wherein the secure computing device is a smart card.
